(19) United States
(12) Patent Application Publication
(10) Pub. No.: US 2024/0183933 A1
(43) Pub. Date: Jun. 6, 2024

(54) METHOD FOR LOCATING A NAVIGATION UNIT

(71) Applicant: Commissariat à l'Energie Atomique et aux Energies Alternatives, Paris (FR)

(72) Inventors: Christophe VILLIEN, GRENOBLE CEDEX 09 (FR); Christophe COMBETTES, GRENOBLE CEDEX 09 (FR)

(73) Assignee: Commissariat à l'Energie Atomique et aux Energies Alternatives, Paris (FR)

(21) Appl. No.: 18/328,017

(22) Filed: Jun. 2, 2023

(30) Foreign Application Priority Data
Jun. 2, 2022 (FR) 22 05306

(51) Int. Cl. G01S 5/14; G01S 5/02

(52) U.S. Cl. CPC G01S 5/145; G01S 5/021

(57) ABSTRACT

A method includes establishing, for a given time, measurement biases allowing an error affecting raw measurements of pseudoranges separating a navigation unit from at least three beacons to be decreased, and estimating an external position of the navigation unit at the given time based on: beacon positions, corrected pseudorange measurements computed for the given time using established measurement biases, and a preceding external position of the navigation unit estimated for a time preceding the given time. The measurement biases are established without taking into account the external position of the navigation unit.

The invention relates to a method for locating a navigation unit. The invention also relates to a data storage medium and navigation unit for implementing this method.

Locating methods allow a navigation unit to be located in an environment containing beacons transmitting messages. For example, these beacons are satellites in orbit around the Earth. When the beacons are satellites, the navigation unit may be thought of as the user segment of the global navigation satellite system (GNSS) in question. The GNSS of the United States of America is known by the acronym GPS, which stands for Global Positioning System.

Typically, known locating methods comprise the following steps:
a) receiving messages transmitted by at least three beacons, then
b) extracting raw measurements of pseudoranges separating the navigation unit from each of the beacons based on the times of receipt of these messages as measured by the navigation unit and on the speed of propagation of these messages through space, then
c) estimating a position of the navigation unit based on the extracted raw measurements.

This prior art is for example disclosed in US2015/268354A1, U.S. Pat. No. 6,324,472B1 and in the article by Al Quingsong et al.: “Evaluation and mitigation of the influence of pseudorange biases on GNSS satellite clock offset estimation”, Measurement, Institute of Measurement and Control, London, Vol. 193, 10/03/2022.

To improve the precision of the estimated position, it is known to correct the raw pseudorange measurements before they are used to estimate the position of the navigation unit. Specifically, the signals transmitted by the beacons may be very noisy.

To correct the raw measurements, the following documents have proposed methods that use the preceding position estimated for the navigation unit:
patent application FR3066027A1, and
A. Giremus, J.-Y. Tourneret and V. Calmettes: “A particle filtering approach for joint detection/estimation of multipath effects on GNSS measurements”, IEEE Trans. Signal Processing, 2007.

These methods are advantageous because they allow the precision of the location to be improved with respect to locating methods that do not make corrections to the raw pseudorange measurements depending on the preceding position of the navigation unit. However, in practice, these methods are not very robust and run the risk of diverging in the course of time. Specifically, an error in the correction of the raw pseudorange measurements introduces an error into the estimated position. In the following iteration of the method, the erroneous estimated position is then used to correct the new raw pseudorange measurements. The error made in the position estimate may thus increase, in the following iteration, the error made in the correction of the raw pseudorange measurements. Hence, feedback may appear that amplifies the error instead of compensating for it.

The invention aims to remedy this drawback by providing a locating method that uses the position of the navigation unit to correct the raw pseudorange measurements while being more robust.

One subject thereof is therefore a method for locating a navigation unit.

Another subject of the invention is a data storage medium that is readable by a microprocessor, comprising instructions that are executable by this microprocessor, wherein this medium comprises non-transitory instructions for executing the above locating method, when these instructions are executed by the microprocessor.

Lastly, another subject of the invention is a navigation unit configured to implement the above method.

The invention will be better understood on reading the following description, which is given solely by way of non-limiting example, with reference to the drawings, in which:

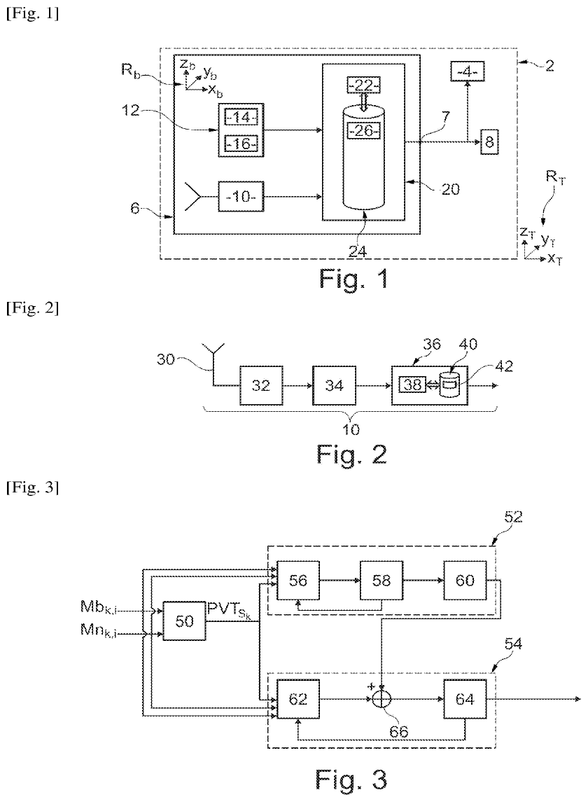

FIG. 1 is a schematic illustration of a system for locating a vehicle comprising a navigation unit;

FIG. 2 is a schematic illustration of the navigation unit of the system of FIG. 1;

FIG. 3 is a schematic illustration of various software modules implemented in the navigation unit of FIG. 2;

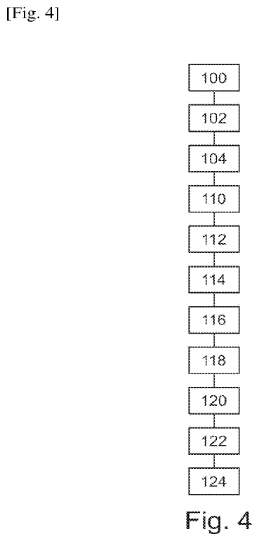

FIG. 4 is a flowchart of a locating method using the navigation unit of FIG. 2;

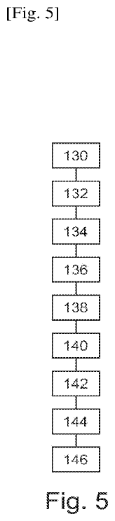

FIG. 5 is a flowchart of a measurement-selecting method implemented in the method of FIG. 4.

In these figures, the same references have been used to designate elements that are the same.

In the remainder of this description, features and functions well known to those skilled in the art are not described in detail.

In this description, detailed examples of embodiments are first described in Section I with reference to the figures. Next, in the following section, Section II, variants of these embodiments are introduced. Lastly, the advantages of the various embodiments are presented in Section III.

### Section I: Examples of Embodiments

Below, a detailed embodiment of the invention is described in the particular context of location of a vehicle on the Earth's surface. In this particular context, the beacons transmitting messages based on which the vehicle may be located are satellites in orbit around the Earth.

FIG. 1 shows a vehicle 2 capable of moving over the Earth's surface. To this end, for example, the vehicle 2 comprises wheels or tracks. The vehicle 2 is also equipped with propulsion means 4 such as an engine that drives the wheels or tracks.

The vehicle 2 is equipped with a geolocation system 6 for locating this vehicle. This system 6 is able to determine the position, orientation and velocity of the vehicle 2 in a terrestrial frame of reference R_{T}. Here, the terrestrial frame of reference R_{T} is fixed without any degree of freedom to the Earth. The frame of reference R_{T} comprises three axes, which are typically orthogonal to one another. A moving frame of reference R_{b} is also fixed with no degree of freedom to the vehicle 2. This frame of reference R_{b} comprises three axes that are orthogonal to one another, denoted x_{b}, y_{b} and z_{b}, respectively.

Here, the position of the vehicle 2 in the frame of reference R_{T} is expressed by the latitude L, the longitude A and the altitude h of the origin of the frame of reference R_{b}.

The orientation of the vehicle 2 is expressed by the yaw angle ψ, the pitch angle θ and the roll angle Φ of the frame of reference R_{b} with respect to the frame of reference R_{T}.

The position, orientation and velocity determined by the system 6 are delivered to an output 7.

Typically, the vehicle 2 comprises a control unit 8 for guiding or assisting in guiding the vehicle 2 to a predefined destination. The unit 8 is connected to the output 7. The control unit 8 may be manual and/or automatic. In the case of a manual control unit, the determined position, orientation and velocity are transmitted to a human-machine interface with a view to assisting a human being in controlling the propulsion means 4. In the case of an automatic control unit, the determined position, orientation and velocity are automatically converted into commands for controlling the propulsion means 4, then automatically transmitted to these propulsion means 4.

The system 6 comprises a navigation unit 10 and an inertial measurement unit 12.

The navigation unit 10 is capable of determining its position in the frame of reference R_{T} based on messages transmitted by the satellites. For example, here, the satellites are satellites of the GPS constellation (GPS standing for Global Positioning System). In this context, the unit 10 is known as a GNSS unit (GNSS being the acronym of global navigation satellite system) and corresponds to the user segment of this GNSS. Based on the satellite signals that it receives, the unit 10 generates signals representative of the position and velocity of the vehicle in the frame of reference R_{T}.

The unit 12 is known as an IMU (acronym of inertial measurement unit). The unit 12 notably comprises a triaxial accelerometer 14 and a triaxial gyrometer 16. By virtue of these sensors, the unit 12 is capable of measuring the variation in the orientation of the vehicle 2.

To determine the position, orientation and velocity of the vehicle 2 based on the measurements of the units 10 and 12, the system 6 comprises a programmable electronic computer 20. This computer 20 is able to acquire the measurements of the units 10 and 12 and, based on these measurements, to determine the position, orientation and velocity of the vehicle 2 in the frame of reference R_{T}. The computer 20 comprises a microprocessor 22 and a memory 24.

The memory 24 notably comprises the instructions of a software module 26 able to determine the position, orientation and velocity of the vehicle 2 based on the measurements of the units 10 and 12 when it is executed by the microprocessor 22. The module 26 notably implements a fusion algorithm that establishes, based on a preceding estimation of the position, orientation and velocity of the vehicle 2 and on new measurements of the units 10 and 12 acquired since this preceding estimation, a new estimation of the position, orientation and velocity of the vehicle 2. The fusion algorithm also establishes margins of error in each new estimation.

Such fusion algorithms are well known to those skilled in the art. For example, a presentation of the prior art on the matter may be found in the following thesis: S. Godha “Performance Evaluation of Low Cost MEMS-Based IMU Integrated With GPS for Land Vehicle Navigation Application”, PhD report, 2006. Below, this thesis is designated by the expression “Godha2006”. Typically, this fusion algorithm implements one or more Kalman filters. Here, the module 26 employs a closed-loop integration scheme or closed-loop approach.

FIG. 2 shows the main components of the unit 10 in more detail. The unit 10 comprises, in succession:
an antenna 30 for receiving the GNSS signals transmitted by the satellites,
an RF front end 32 connected to the antenna 30 and that carries out amplification, filtering, frequency transposition and digitization of the transmitted GNSS signals,
a baseband processor 34 that receives the signals processed by the RF front end 32, and
a navigation processor 36 that processes the data transmitted by the baseband processor 34 with a view to locating the unit 10.

The baseband processor 34 acquires the signals processed by the RF front end 32, demodulates them and extracts from the demodulated signals the following data:
raw measurements Mb relative to these signals, and
messages Mn transmitted by the satellites.

The messages transmitted by the satellites are known as GNSS messages.

Typically, the raw measurements Mb contain, for each satellite that transmitted a GNSS signal received by the unit 10, at least one raw measurement Mb_{k,i} of the pseudorange separating the unit 10 from this satellite. For example, this raw pseudorange measurement Mb_{k,i} is here computed using the following relationship: Mb_{k,i}=(tr_{k,i}−te_{k,i})×c, where:
the index i is a satellite identifier,
the index k is an identifier of a time tₖ defined below,
Mb_{k,i} is the raw measurement of the pseudorange between the unit 10 and the satellite identified by the index i,
tr_{k,i} is the time of receipt of the message as measured by the baseband processor 34,
te_{k,i} is the time of transmission of the message by satellite i, this time te_{k,i} here being contained in the message transmitted by the satellite,
c is the speed of light, and
“x” is the symbol representing the operation of multiplication.

The raw measurements may potentially contain other measurements for each satellite, such as:
a Doppler or frequency-shift measurement,
a measurement of the phase of the carrier wave of the transmitted GNSS signal, and
the time of receipt of the transmitted GNSS signal.

These other measurements may be used to estimate, in addition to the position of the unit 10, other physical quantities such as the velocity or clock error of the unit 10. Below, when physical quantities other than the position of the unit 10 are estimated, these other physical quantities are considered to have been estimated in a conventional manner. Thus, below, only processing of the raw pseudorange measurements is described in detail.

The messages Mn contain, for each satellite that transmitted a GNSS signal received by the unit 10: ephemerides or parameters allowing the positions and velocities of the satellite to be estimated. The messages Mn also potentially contain, for each satellite, other data such as:
parameters of corrections of satellite clock errors,
elements characterizing the state of the satellite and the state of its measurement,
parameters of a model for estimating propagation times through the ionosphere and the troposphere.

The navigation processor 36 typically comprises a microprocessor 38 and a memory 40. The memory 40 contains the instructions of a locating software package 42 which locates the unit 10 based on the signals transmitted by the satellites when it is executed by the microprocessor 38. In this embodiment, locating the unit 10 means computing the position, velocity and clock error of the unit 10, i.e. computing a PVT (position, velocity, time) for the unit 10.

More precisely, the software package 42 updates the PVT of the unit 10 at each time tₖ of a temporal sequence of times {t₀; . . . ; tₖ₋₁; tₖ; . . . }. For example, this temporal sequence is a periodic sequence of times tₖ and the period between two successive times tₖ is equal to the sampling period of the GNSS signals. Below, the PVT delivered by the unit 10 to the computer 20 at time tₖ is denoted PVTₖ. In this text, the index k is also used to identify the new measurements, the new messages and the new physical quantities used to estimate PVTₖ. Thus, the new raw measurements Mb and the new messages Mn obtained from the GNSS signal of a satellite and used to estimate PVTₖ are denoted Mb_{k,i} and Mn_{k,i}, respectively, where the index i is an identifier of this satellite. To estimate PVT_{k,i} the measurements Mb_{k,i} and the messages Mn_{k,i} of at least three, and in this embodiment at least four, satellites are used. In practice, the number of satellites from which GNSS messages are received by the unit 10 is often higher than five or eight. Thus, the index i is here an integer that varies from 1 to more than 4, 5 or 8.

FIG. 3 shows the architecture of the locating software package 42. The software package 42 comprises a module 50 for estimating the position of the satellites based on the measurements Mb_{k,i} and on the data contained in the messages Mn_{k,i} i. More precisely, here, for each time t_{k,i} module 50 estimates new positions, new velocities and new clock errors of the satellites based on the measurements Mb_{k,i} and messages Mn_{k,i} received since the preceding time tₖ₋₁. In other words, the module 50 estimates the PVT of each satellite i for the time tₖ. This PVT of satellite i for the time tₖ is denoted PVTs_{k,i} below. The vector the i-th coordinate of which is equal to PVTs_{k,i} is denoted PVTsₖ.

Many methods are known for estimating PVTs_{k,i} based on the measurements Mb_{k,i} and messages Mn_{k,i}. For example, to start with, the transmission times of the GNSS signals are estimated based on:
measurement of the times of receipt trₖ of these GNSS signals by the unit 10, and
measurement of the pseudoranges between the satellites and the antenna 30.

Subsequently, the positions, velocities and clock errors of the satellites are estimated by executing an algorithm that uses parameters delivered in the messages Mn_{k,i}. For example, this algorithm is one of those provided in the following articles:
Global navigation satellite system Glonass ICD Navigational radiosignal in bands L1, L2, Edition 5.1, Russian Institute of Space Device Engineering, 2008, pages 41-49;
Navstar GPS Space Segment/Navigation User Interfaces, IS-GPS-200, Revision D, ARINC, March 2006, pages 83-98.

Next, the software package 42 implements:
a process 52 that establishes measurement biases c2_{k,i} that are practically independent of the preceding PVT, i.e. PVTₖ₋₁, and
a process 54 that estimates PVTₖ while using the measurement biases c2_{k,i} to correct the raw measurements Mb_{k,i} and thus improve the precision of PVTₖ.

A measurement bias is a value that, when it is subtracted from a raw measurement, allows the error affecting this raw measurement to be decreased.

The process 52 receives as input the measurements Mb_{k,i}, the data contained in the messages Mn_{k,i} and the PVTs_{k,i} estimated by the module 50. This process 52 delivers as output the biases c2_{k,i} established. This process 52 contains three modules that are executed one after another: a module 56 for correcting and selecting measurements, a module 58 for estimating an internal position P1ₖ and a module 60 for estimating biases c2_{k,i}.

The process 54 of estimating PVTₖ has as input data: the PVTs_{k,i}, the messages Mn_{k,i}, the raw measurements Mb_{k,i} and the biases c2_{k,i} established by process 52. This process 54 is divided into two modules, which are executed one after the other: a module 62 for correcting and selecting the measurements Mb_{k,i}, which delivers pre-corrected measurements Mc2_{k,i}, and a module 64 for estimating an external PVT denoted PVT2ₖ. The external PVT is delivered to the computer 20. Thus, PVT2ₖ and PVTₖ are the same. Process 54 also comprises a subtractor 66 that subtracts the biases c2_{k,i} from the pre-corrected measurements Mc2_{k,i} delivered by module 62.

Examples of embodiment of the various modules of the software package 42 and the operation of the unit 10 will now be described with reference to the method of FIG. 4.

For each time tₖ for which a new PVTₖ must be delivered to the computer 20, the unit 10 executes the following steps.

In a step 100, the RF front end 32 receives new GNSS signals transmitted by at least three satellites. These GNSS signals are qualified “new” in the sense that they are received after the GNSS signals used to estimate the preceding PVT, PVTₖ₋₁.

Typically, in step 100, the RF front end 32 receives the GNSS signals transmitted by more than four, and conventionally more than eight, satellites.

In a step 102, the baseband processor 34 extracts, for each of the satellites, from the received new GNSS signals, the raw measurements Mb_{k,i} and the transmitted messages Mn_{k,i} i.

Next, in a step 104, module 50 estimates new PVTs, which are denoted PVTs_{k,i}, based on the measurements Mb_{k,i} and on the received messages Mn_{k,i}.

In a step 110, module 56 pre-corrects the measurements Mb_{k,i} to obtain pre-corrected measurements Mc1_{k,i}. Here, the pre-corrected measurements Mc1_{k,i} are obtained based on the measurements Mb_{k,i}, on the data contained in the messages Mn_{k,i}, on the PVTs_{k,i} estimated by module 50 and on the preceding internal position P1ₖ₋₁.

Typically, the pre-corrected measurements Mc1_{k,i} are obtained using the following relationship:

Mc1_{k,i}=Mb_{k,i}−c1_{k,i}
where c1_{k,i} is the correction estimated in this step.

The correction c1_{k,i} is established using a predetermined model m1 of the perturbations introduced by the fact that the GNSS signals pass through the ionosphere and the troposphere. Here, this model m1 is parametrized by the PVTs_{k,i} and the position P1ₖ₋₁. For example, here the model m1 is the model defined in the following article: Collins, J. P., Assessment and Development of a Tropospheric Delay Model for Aircraft Users of the Global Positioning System, Technical Report No. 203, University of New Brunswick, 1999, pages 96-97. In this case, the correction c1_{k,i} is computed using the following relationship, relationship (2):

$$\\ c {1}_{k , i} = \frac{A ( P {1}_{k - 1} )}{sin ( θ ) + \frac{0.00143}{tan ( θ ) + 0.0455}}$$

where:
   the angle θ is the elevation angle, i.e. the angle between the plane tangent to the Earth's surface at the point defined by the position P1ₖ₋₁ and the straight line connecting the satellite to this point on the Earth, and
   A(P1ₖ₋₁) is a function defined by the following relationship:

$$\\ A = \{ \begin{matrix}2.464 - 3.248 \times {10}^{- 4} \times h + 0.2395 \times {10}^{- 8} \times {h}^{2} ; h < 1000 m \\ 2.284 \times exp ( - 0.1226 \times ( h \times {10}^{- 3} - 1 ) ) - 0.122 ; 1000 m < h < 9000 m \\ 0.7374 \times exp ( 1.2816 - 1.424 \times {10}^{- 4} \times h ) ; 9000 m < h\end{matrix}$$

where:
   h is the orthometric height of the unit 10, which is obtained based on the position P1ₖ₋₁, and
   for each row of this relationship, the inequality after the semicolon indicates for which range of orthometric heights this row must be used to compute A(P1ₖ₋₁),
   m means the unit of length metres.

Orthometric height h is estimated based on the position P1ₖ₋₁ and a geodetic system.

In a step 112, module 56 selects pre-corrected measurements Mc1_{k,i}, these being the only ones to be used in the rest of process 52. The aim of this selection is to eliminate measurements Mc1_{k,i} considered to be excessively erroneous, in order to prevent them from being taken into account in the estimation of the position P1ₖ. This allows precision to be improved. One detailed example of embodiment of this step 112 is described below with reference to FIG. 5. The following steps of process 52 use only the measurements selected in step 112 to compute the biases c2_{k,i}. Measurements that are not selected are not used to compute the biases c2_{k,i}, and hence the biases c2_{k,i} the index i of which corresponds to a not selected measurement are not updated by process 52 for time tₖ. In other words, for indices i that correspond to not selected measurements, the bias c2_{k,i} is set equal to c2_{k-1,i}. Similarly, for indices i that correspond to not selected measurements, the variance of the bias c2_{k,i} is not updated. It is therefore equal to the variance of the bias c2_{k-1,i}. For the following steps of process 52, the index i corresponds only to the indices i of the selected measurements.

In a step 114, module 58 estimates the position P1ₖ based on the pre-corrected measurements Mc1_{k,i} selected in step 112, on the PVTs_{k,i} estimated in step 104 and on the preceding position P1ₖ₋₁.

Here, module 58 estimates the position P1ₖ by minimizing the following cost function f₁:

$$\\ {f}_{1} ( X , Mc {1}_{k , i} , {PVT}_{{S}_{k}} ) = {\sum }_{i ∈ Ipmin} {{ω}_{i} ( Mc {1}_{k , i} - ( ‖ \begin{matrix}{x}_{k} - {xs}_{k , i} \\ {y}_{k} - {ys}_{k , i} \\ {z}_{k} - {zs}_{k , i}\end{matrix} ‖ + {x}_{t , k} ) )}^{2}$$

where:
   xₖ, yₖ, zₖ are the spatial coordinates of the position P1ₖ of the unit 10 that are to be determined,
   x_{t,k} is the clock error of the unit 10 that is to be determined, expressed in the form of a distance added to the computed pseudorange,
   X is the vector of coordinates xₖ, yₖ, zₖ and x_{t,k},
   xs_{k,i}, ys_{k,i} and zs_{k,i} are the spatial coordinates of satellite i obtained from the PVTs_{k,i} estimated by module 50,
   Mc1_{k,i} is the i-th measurement pre-corrected in step 110,
   wᵢ is a weight assigned to the i-th measurement Mc1_{k,i}, and
   Ipmin is the set that contains the indices i of the measurements selected in step 112.

The value of each weight wᵢ is predetermined depending, for example, on the elevation of satellite i, on the signal-to-noise ratio measured for satellite i, and on the rate at which the distance between the unit 10 and this satellite is varying. In one simplified variant, the weights wᵢ are constant and, for example, all equal to one.

The values of the coordinates of the vector X that minimize the cost function f₁ are estimated using a Gauss-Newton algorithm for example, or any other optimization algorithm such as, inter alia, Levenberg-Marquardt or gradient-descent algorithms, which are generally iterative algorithms. The initial values of the coordinates of the vector X are for example set equal to zero. Here, the search for values of the coordinates of the vector X that minimize the function f₁ is stopped:
after a predetermined number of iterations, for example comprised between two and twenty, or
when the update of the vector X becomes small, i.e. when the norm of the difference between the vector X obtained at the end of the current iteration and the vector X obtained at the end of the preceding iteration drops below a predetermined threshold. This predetermined threshold is, for example, comprised between 10⁻⁴ and 10⁻¹⁰.

In a step 116, module 60 establishes the values of the biases c2_{k,i} based on the pre-corrected measurements Mc1_{k,i}, on the PVTs_{k,i} and on the position P1ₖ. Here, the measurement biases c2_{k,i} are estimated by minimizing a cost function, denoted f₂, dependent on the measurement biases c2_{k-1,i} established for the preceding time tₖ₋₁.

For example, the cost function f₂ is defined by the following relationship:

f₂(X,Mc1_{k,i}P1ₖ,c1_{k-1,i})=∥r(Mc1ₖ,P1ₖ)−X∥_{R}_{_{c}}_{^{−1}}+∥X−c2ₖ₋1∥_{P}_{_{c,k−1}}_{^{−}}²
where:
   Mc1ₖ is the vector formed by the measurements Mc1_{k,i} for i belonging to the set Ipmin,
   c2ₖ₋₁ is the vector formed by the biases c2_{k-1,i} for i belonging to the set Ipmin.

The function r(Mc1_{k,i} P1ₖ) is a vector of measurement residues between Mc1ₖ and the measurements estimated depending on P1ₖ. The i-th component rᵢ of the vector of residues is defined by the following relationship:

$$\\ {r}_{i} = Mc {1}_{k , i} - ( \sqrt{{( {x}_{k} - {xs}_{k , i} )}^{2} + {( {y}_{k} - {ys}_{k , i} )}^{2} + {( {z}_{k} - {zs}_{k , i} )}^{2}} + {x}_{t , k} ) .$$

In this text, the symbol ∥A∥_{R}_{^{−1}}² designates the norm to the power of two of the vector A generated by the scalar product defined by the positive definite matrix R⁻¹. This norm is defined by the following relationship:

∥A∥_{R}_{^{−1}}²=A^{T}R⁻¹A
where, in this text, the symbol “^{T}” designates the transpose operation, and the symbol “⁻¹” designates the operation of inversion of a matrix.

The matrix R_{c} is the covariance matrix of the residues of the vector r(Mc1_{k,i} P1ₖ) For example, here, the matrix R_{c} is diagonal and its elements are all equal to 25 m².

The matrix P_{c,k} is the covariance matrix of the biases c2_{k,i}. It is updated for each time tₖ according to the following relationship:

P_{c,k}=(R_{c,k-1}⁻¹+R_{c}⁻¹)⁻¹

Once the biases c2_{k,i} have been established, execution of process 52 terminates and execution of process 54 begins.

In a step 118, module 62 pre-corrects the measurements Mb_{k,i} to obtain second pre-corrected measurements Mc2_{k,i}. Here, the pre-corrected measurements Mc2_{k,i} are obtained based on the measurements Mb_{k,i}, on the data contained in the messages Mn_{k,i}, on the PVTs_{k,i} estimated by module 50 and on the preceding external PVT2, PVT2ₖ₋₁. Here, step 118 is identical to step 110 except that the position P2ₖ₋1 contained in PVT2ₖ₋₁ is used instead of the position P1ₖ₋₁.

Once steps 114 and 118 have terminated, in a step 120, corrected measurements Mc3_{k,i} are computed using the following relationship:

Mc3_{k,i}=Mc2_{k,i}−c2_{k,i}

Next, in a step 122, module 64 estimates PVT2ₖ based on the PVTs of the satellites, i.e. on the PVTs_{k,i}, on the corrected measurements Mc3_{k,i} and on the preceding PVT2, i.e. on PVT2ₖ₋₁. In this example of embodiment, PVT2ₖ is estimated by minimizing the following cost function f₃:

f₃(X,Mc3_{k,i},PVTs_{k,i},PVTs_{k-1,i})=∥Mc3ₖ−h(X)∥_{R}_{_{Mc3}}_{^{−}}²+∥X−f(PVT2ₖ₋1)∥_{P}_{_{PVT2}}_{^{−1}}²
where:
   X is the variable allowing the function f₃ to be minimized, it contains PVT2_{k,i} and therefore the following elements: X^{T}=(x, y, z, vₓ, v_{y}, v_{z}, xₜ, dxₜ), with:
   x, y and z the coordinates of the position P2^{k} of the unit 10 in the frame of reference R_{T},
   vₓ, v_{y} and v_{z} the components of the velocity vector V2ₖ of the unit 10 in the frame of reference R_{T},
   xₜ the clock bias of the unit 10 with respect to GPS time,
   dxₜ the drift of the clock of the unit 10 with respect to GPS time,
   h(X) the measurement function the i-th component of which is defined by the following relationship:

hᵢ(X)=\sqrt{(x−xs_{k,i})²+(y−ys_{k,i})²+(z−zs_{k,i})²}+xₜ
Mc3ₖ is the vector the i-th component of which is Mc3_{k,i},
PVT2ₖ₋₁ is the vector PVT2ₖ estimated for time tₖ₋₁,
R_{Mc3} is the covariance matrix of the measurements Mc3_{k,i}, it is diagonal and each diagonal element is, here, set to 25 m²
f is the function defined by the following relationship:

$$\\ f ( X ) = FX , F = ( \begin{matrix}\begin{matrix}{I}_{3 \times 3} & dt \times {I}_{3 \times 3} \\ {0}_{3 \times 3} & {I}_{3 \times 3}\end{matrix} & \begin{matrix}{0}_{3 \times 1} & {0}_{3 \times 1} \\ {0}_{3 \times 1} & {0}_{3 \times 1}\end{matrix} \\ \begin{matrix}{0}_{1 \times 3} & {0}_{1 \times 3} \\ {0}_{1 \times 3} & {0}_{1 \times 3}\end{matrix} & \begin{matrix}1 & dt \\ 0 & 1\end{matrix}\end{matrix} )$$

with:
   I_{n×p} the identity matrix of size n by p,
   0_{n×p} the null matrix of size n by p,
   dt the sampling period, here it is equal to tₖ−tₖ₋₁,
   P_{PVT2} is an estimation of the covariance matrix of PVT2_{k,i} it is obtained using the following relationship:

P_{PVT2}=FP_{PVT2,k-1}F^{T}+Q
where:
   P_{PVT2,k-1} is the covariance matrix of the preceding PVT2, PVT2ₖ₋₁, and
   Q is a positive symmetric matrix the values of which are given by the following relationship:

$$\\ Q = ( \begin{matrix}\begin{matrix}{0}_{3 \times 3} & {0}_{3 \times 3} \\ {0}_{3 \times 3} & dt \times 10 \times {I}_{3 \times 3}\end{matrix} & \begin{matrix}{0}_{3 \times 1} & {0}_{3 \times 1} \\ {0}_{3 \times 1} & {0}_{3 \times 1}\end{matrix} \\ \begin{matrix}{0}_{1 \times 3} & {0}_{1 \times 3} \\ {0}_{1 \times 3} & {0}_{1 \times 3}\end{matrix} & \begin{matrix}dt \times 0.01 & 0 \\ 0 & dt \times 0.04\end{matrix}\end{matrix} )$$

For example, the cost function f₃ is minimized using the Gauss-Newton method.

In a step 124, module 64 updates the estimate P_{PVT2} of the covariance matrix of PVT2ₖ using the following relationship:

P_{PVT2,k}(P_{PVT2}⁻¹+H^{T}R_{Mc3}⁻¹H)⁻¹
where:
   H is the Jacobian matrix of the function h(X) defined above in step 122, and
   P_{PVT2} is the estimate of the covariance matrix computed in step 122.

For the initial time t₀, PVT2₋₁ is defined as being the null vector and the covariance matrix P_{PVT2,-1} is the diagonal matrix defined by the following relationship:

$$\\ {P}_{PVT 2 , - 1} = ( \begin{matrix}\begin{matrix}{10}^{{}^{} 12} \times {I}_{3 \times 3} & {0}_{3 \times 3} \\ {0}_{3 \times 3} & {10}^{{}^{} 2} \times {I}_{3 \times 3}\end{matrix} & \begin{matrix}{0}_{3 \times 1} & {0}_{3 \times 1} \\ {0}_{3 \times 1} & {0}_{3 \times 1}\end{matrix} \\ \begin{matrix}{0}_{1 \times 3} & {0}_{1 \times 3} \\ {0}_{1 \times 3} & {0}_{1 \times 3}\end{matrix} & \begin{matrix}{10}^{{}^{} 12} & 0 \\ 0 & {10}^{{}^{} 2}\end{matrix}\end{matrix} )$$

One example of embodiment of step 112 of selecting measurements will now be described in detail with reference to the method of FIG. 5.

In an operation 130, module 56 computes a score s1₀, for each satellite using the following relationship:

$$\\ s {1}_{{0}_{, i}} = \frac{1}{N + 1} {\sum }_{j = 0}^{N} cn {0}_{i} ( k - j )$$

where:
   cn0ᵢ(k−j) is the measurement of the signal-to-noise ratio for satellite i at time tₖ₋ⱼ, and
   N is a predetermined integer higher than one and, preferably, higher than ten or twenty.

Typically, the measurement cn0ᵢ(k−j) is carried out in step 102 by the baseband processor 34.

Next, in an operation 132, module 56 selects the M best measurements in the sense of the score s1_{0,i}. For example, M is equal to eight.

Lastly, a process of detecting and excluding faults based on a sub-set testing approach is used to select the best sub-set of measurements among the M best measurements. To limit computations, the maximum number of faults sought is limited to Mex=2.

More precisely, the best sub-set is selected as follows.

In an operation 134, module 56 generates all the possible sub-sets Eₚ of M-Mex measurements among the M best measurements, where the index p is a sub-set identifier.

Next, for each generated sub-set EP, module 56 executes the following operations, operations 136 to 140.

In operation 136, module 56 computes the position P1_{k,p} based on the measurements of the sub-set EP by minimizing the following cost function f₁:

$$\\ {f}_{1} ( X , Mc {1}_{k , i} , {PVT}_{{S}_{k}} ) = {\sum }_{i ∈ Ip} {{ω}_{i} ( Mc {1}_{k , i} - ( ‖ \begin{matrix}x - {xs}_{k , i} \\ y - {ys}_{k , i} \\ z - {zs}_{k , i}\end{matrix} ‖ + {x}_{t , k} ) )}^{2}$$

This function f₁ is identical to the function f₁ used in step 114 except that the set Ip is the set that contains the indices i of the measurements contained in the sub-set Eₚ. The position minimizing this cost function f₁ is found by applying, for example, the same algorithm as was implemented in step 114.

In an operation 138, module 56 computes the following metrics for each sub-set Eₚ: a residue rₚ, a geometric dilution GDOPₚ and a maximum sensitivity of the position error with respect to the residue rₚ, which is denoted SlopeMaxp.

The residue rₚ is equal to the norm of the vector r(Mc1_{k,p}, P1_{k,p}), where:
Mc1_{k,p} are the measurements contained in the sub-set Eₚ, and
r( . . . ) is the same function as defined in step 116.

The geometric dilution is better known as the geometric dilution of precision. Here it is computed taking into account the position of each of the satellites from which the measurements Mc1_{k,i} of the sub-set Eₚ and the position P1_{k,p} were obtained.

The parameter SlopeMaxₚ is computed as defined on pages 105 to 136 of the following document: Salos Andres, C. D, Integrity monitoring applied to the reception of GNSS signals in urban environments, PhD Thesis, Institut National Polytechnique de Toulouse, 2012.

In an operation 140, module 56 computes, for each set Eₚ, a score s1_{1,p} using the following relationship:

s1_{1,p}=α₁∥rₚ∥²+α₂GDOPₚ+α₃SlopeMax,
where α₁, α₂ and α₃ are predetermined weighting coefficients.

In an operation 142, module 56 selects the sub-set Eₚ that has the lowest score s1_{1,p}. The selected sub-set is denoted Eₚₘᵢₙ.

In an operation 144, module 56 validates the best sub-set Eₚₘᵢₙ, by comparing the metrics rₚₘᵢₙ, GDOPₚₘᵢₙ and SlopeMaxₚₘᵢₙ computed for the sub-set Eₚₘᵢₙ to predetermined thresholds, Thr0, ThGDOP and ThSlopeMax, respectively. If each of the metrics rₚₘᵢₙ, GDOPₚₘᵢₙ and SlopeMaxₚₘᵢₙ is lower than its respective threshold, then the sub-set Eₚₘᵢₙ is validated. In the contrary case, fault detection is said to be impossible, and no measurement is validated. When no measurement is validated, the biases c2_{k,i} are considered unchanged and set equal to the biases c2_{k-1,i}.

Only if the best sub-set Eₚₘᵢₙ has been validated, in an operation 146, module 56 computes the consistency of the remaining measurements with respect to the selected sub-set Eₚₘᵢₙ. The remaining measurements are those not belonging to the sub-set Eₚₘᵢₙ. Consistency is tested by comparing, to a predetermined threshold Thr1, each residue of the remaining measurements. The residue of each remaining measurement is computed using the following relationship:

rᵢ=Mc1_{k,i}−h(P1_{k,pmin})
where:
   the function h( ) is the same function as implemented in step 122, and
   the indices i here correspond only to the indices i of the remaining measurements.

A remaining measurement is consistent with the measurements of the sub-set Eₚₘᵢₙ if the residue rᵢ computed for this remaining measurement is less than a predetermined threshold Thr1. Next, all the remaining measurements that are consistent with the measurements of the sub-set Eₚₘᵢₙ are added to the sub-set Eₚₘᵢₙ and therefore used in the rest of process 52. In contrast, inconsistent remaining measurements are not used in the rest of process 52.

### Section II: Variants

### Variants of the Navigation Unit:

The navigation unit 10 has been described in the particular case of use within a locating system comprising, in addition, the inertial measurement unit 12. However, the unit 10 may be used in any locating system and, in particular, in locating systems not comprising any inertial measurement unit or comprising, in addition or instead, other sensors such as an odometer.

The beacons may be satellites of one or more constellations such as GPS (acronym of Global Positioning System), Glonass, Galileo and Beidou.

What has been described in the particular case where the beacons are satellites may be applied to any locating system and, in particular, to locating systems where the beacons are not satellites. For example, what has been described here may also be implemented in the case where the beacons are fixed beacons on Earth transmitting messages. For example, such fixed beacons may be installed in a shopping centre to locate pedestrians or be installed in proximity to an aerial lift to locate the position of a cable car. These fixed beacons are for example ultra-wide band (UWB) beacons. The term “ultra-wideband beacon” or “UWB beacon” here designates a transceiver that uses a wide frequency band to send and receive the messages. A “wide” frequency band is a frequency band the width of which is larger than 0.2f_{c}, where f_{c} is the central frequency of this frequency band. Typically, a wide frequency band has a width larger than 250 MHz or even larger than 400 MHz.

Instead of emitting electromagnetic waves to transmit the messages, the beacons may emit ultrasound. In this case, the speed of propagation of the messages through space is equal to the speed of sound and not to the speed of light.

### Variants of the Locating Method:

To measure a pseudorange, it is not necessary for the messages transmitted by the beacons to contain the time of transmission of this message. For example, this is not necessary if the clocks of the beacons and of the navigation unit are temporally synchronized with one another. In this case, for example, the beacons transmit the messages at times teₖ known to the navigation unit and hence these times teₖ do not need to be contained in the transmitted messages. According to another variant, the times te_{k,i} of transmission are computed by the navigation unit, for example based on a time of transmission of a message by the navigation unit and on the time of receipt of the response to this message transmitted by the beacon.

Step 110 of pre-correcting the raw measurement may be carried out differently. In particular, there are other models of the perturbations introduced by the ionosphere or troposphere that are usable instead of the STANAG model. In particular, the model used may also be parametrized by data contained in the messages Mn_{k,i}. In the case where the beacons are not satellites, another model of the perturbations introduced by the exterior environment through which the navigation unit is moving may be used. In one simplified embodiment, step 110 of pre-correcting the raw measurements is omitted. Specifically, in certain contexts, such as in the case where the beacons are fixed to the surface of the Earth, such pre-correction may be needless.

Step 112 of selecting corrected measurements may be carried out differently. For example, one of the fault detection and exclusion methods described in the following articles may be used instead of the method described in Section I:
H. Kuusniemi, G. Lachapelle: “GNSS Signal Reliability Testing in Urban and Indoor Environments”, Proceedings of the 2004 National Technical Meeting of The Institute of Navigation, San Diego, CA, pp. 210-224, 2004;
N. Zhu: “GNSS Propagation Channel Modeling in Constrained Environments: Contribution to the Improvements of the Geolocation Service Quality”, PhD thesis, University of Lille FR, 2018.

In another variant of step 112, instead of using PVT2ₖ₋₁ to make the selection, PVT1ₖ₋₁ is used. Other methods for selecting the best sub-set of measurements from the M best measurements in the sense of the score s1_{0,i} may be used. Scores other than the scores s1_{0,i} and s1_{1,p} may also be used to select the best measurements.

In one simplified embodiment, the selecting step 112 is omitted.

Other embodiments of step 114 of estimating the position P1_{k,i} are possible. For example, as a variant, it is an internal PVT, PVT1_{k,i}, that is estimated and not only the internal position P1_{k,i}. The internal velocity V1_{k,i} may be estimated based on Doppler measurements extracted by the baseband processor 34. In the latter case, the various variants described below of step 122 of estimating PVT2_{k,i} are applicable to step 114.

As a variant, in step 116, the data contained in the messages Mn_{k,i} may also be taken into account to establish the values of the biases c2_{k,i}. Other cost functions are usable instead of the cost function f₂ to establish the biases c2_{k,i}. For example, in one simplified embodiment, the biases c2_{k,i} are established by minimizing the following cost function f_{2,1}:

f_{2,1}(X,Mc1_{k,i},P1ₖ)=∥r(Mc1ₖ,P1ₖ)−X∥_{R}_{_{c}}_{^{−1}}²
The biases c2_{k,i} may also be established using a Kalman filter instead of minimizing a cost function.

There are yet other methods of estimating the biases c2_{k,i}. For example, process 52 is replaced by N processes 52^{(p)} that run in parallel to one another, where the exponent (p) is an identifier of the process. The exponent (p) is an integer comprised between 1 and N. Each process 52^{(p)} delivers as output respective biases denoted c2_{k,i}^{(p)}. Here, the measurement biases c2_{k,i}^{(p)} are established by each process 52(p) by executing steps 110, 112, 114 and 116 described above but with different parameters from those used by the other processes 52^{(p)}. In this example, the function f₂ is parametrized by the matrices R_{c} and P_{c,k-1} and each process 52^{(p)} corresponds to specific values of the coefficients of these matrices R_{c} and P_{c,k-1}. For example, process 52⁽¹⁾ uses matrices R_{c}⁽¹⁾ and P_{c,k-1}⁽¹⁾ that are identical to the matrices R_{c} and P_{c,k-1} used in the case of the method of FIG. 4. Process 52⁽²⁾ uses matrices, R_{c}⁽²⁾ and P_{c,k-1}⁽²⁾ respectively, the coefficients of which are for example ten times lower than the corresponding coefficients of the matrices R_{c}⁽¹⁾ and P_{cmk-1}⁽¹⁾. In contrast, process 52⁽³⁾ uses matrices, R_{c}⁽³⁾ and P_{c,k-1}⁽³⁾ respectively, the coefficients of which are for example ten times higher than the corresponding coefficients of the matrices R_{c}⁽¹⁾ and P_{c,k-1}⁽¹⁾.

Next, the best set of biases c2_{k,i}^{(p)} is selected from the N set of biases c2_{k,i}^{(p)} established by the processes 52^{(p)}. Each bias c2_{k,i} is then set equal to the bias c2_{k,i}^{(p)} of the best set of biases c2_{k,i}^{(p)}. For example, the criterion used to select the best set of biases c2_{k,i}^{(p)} is the norm of the innovation denoted nino^{(p)} and each bias c2_{k,i} is equal to the bias c2_{k,i}^{(p)} of the set of biases c2_{k,i}^{(p)} that possesses the lowest value nino^{(p)}. For example, the norm nino^{(p)} of the set of biases c2_{k,i}^{(p)} is defined by the following relationship:

nino^{(p)}=∥Mc2ₖ−c2ₖ^{(p)}−h(f(PVT2^{k-1}))∥
where:
   Mc2ₖ is the vector the coefficients of which are the corrected measurements Mc2_{k,i}
   c2ₖ^{(p)} is the vector the coefficients of which are the biases c2_{k,i}^{(p)},
   PVT2ₖ₋₁ is the vector PVT2ₖ estimated for time tₖ₋₁,
   the functions h( ) and f( ) are the same as those used in the function f₃ described above.

After step 116 of establishing the biases c2_{k,i} and before step 120 of correcting the measurements Mb_{k,i} with the biases c2_{k,i}, the method may comprise other steps. For example, the method comprises a step of testing the update of the measurement biases c2_{k,i}. This testing step makes it possible to detect whether the update of the biases c2_{k,i} complies with a confidence indicator such as the expected standard deviation. For example, the test carried out is the test defined by the following relationship for each of the indices i of the set Ipmin:

|rᵢ(Mc1_{k,i},P1ₖ)−c2ₖ₋₁|<α\sqrt{(R_{c}+P_{c})ᵢᵢ}
where:
   rᵢ(Mc1_{k,i} P1) is the same function as defined above in step 116, and
   the notation (M)ᵢᵢ designates the i-th diagonal element of the matrix M,
   R_{c} and P_{c} are the same matrices as defined in step 116,
   α is a predetermined coefficient set by the user.

If, for each of the indices i of the set Iₚₘᵢₙ, the above test is passed, then the update is accepted. In the contrary case, the update is deleted and the values of the biases c2_{k,i} are not changed, i.e. they are set equal to the values of the biases c2_{k-1,i}.

Other confidence indicators may be established in respect of the precision of the established biases c2_{k,i}. For example, in the case where the biases c2_{k,i} are established by a Kalman filter, the estimated covariance associated with each bias c2_{k,i} is such an indicator of precision.

After step 116 of establishing the biases c2_{k,i} and before step 120 of correcting the measurements Mb_{k,i} with the biases c2_{k,i}, the method may also comprise a step of filtering the biases c2_{k,i}, for example using a moving average or a Kalman filter, in order to make their estimation more precise. It is then the filtered biases that are used to obtain the corrected measurements Mc3_{k,i}.

Step 118 may be executed before one of steps 110, 112 and 114.

As a variant, in step 118, the pre-corrected measurements Mc2_{k,i} are simply set equal to the pre-corrected measurements Mc1_{k,i}. As a variant, step 118 is omitted.

Between steps 118 and 120, as a variant, the module 62 selects pre-corrected measurements Mc2_{k,i}, these then being the only ones to be used in the rest of process 54. For example, the module 62 carries out this selecting step in the same way as step 112 or its variants.

Many variants of step 122 of estimating PVT2_{k,i} are possible. For example, PVT2_{k,i} may also be estimated taking into account the data contained in the messages Mn_{k,i}.

The described computation of PVT2ₖ uses, among other input data, a matrix R_{Mc3} defining the precision of each of the measurements. This matrix R_{Mc3} need not remain constant. For example, it is adjusted depending on the bias correction applied in step 118 and on the confidence accorded to this correction, in order to better reflect the uncertainty in each measurement at the end of this correction.

Many other algorithms may be used to determine a position, a PVT or indeed a PT based on the input data. For example, Kalman filters, particle filters or artificial-intelligence algorithms may also be used. In addition, as illustrated in the embodiment of Section I, a position, a PVT or indeed a PT may also be computed based on a sub-set of the available input signals. In other words, certain signals may be deliberately excluded from the computation if it is determined that they are associated with an excessively erroneous measurement. Many algorithms for selecting satellite signals are known in the art.

In one simplified embodiment, the unit 10 delivers only its position. Its velocity and its clock error are not computed or are not delivered to the computer 20. When the clock error is not computed, the minimum number of satellites required to determine the position of the unit 10 is equal to three. In addition, in this case, the raw measurements may be only pseudorange measurements. Other measurements, such as of the Doppler effect, are omitted.

### Section III: Advantages of the Described Embodiments

Since the biases are established taking into account the internal position of the navigation unit, the biases are more precise that those computed without taking into account the position of the navigation unit. In addition, since the biases are established without taking into account the external position of the navigation unit, the stability and robustness of the locating method are improved. Specifically, an error in the establishment of the biases may propagate to the estimation of the external position. In contrast, the error in the estimation of the external position cannot propagate to the establishment of bias. Thus, the stability and robustness of the locating method are enhanced without however deteriorating precision.

Selecting, using the external position at the preceding time tₖ₋₁, beacons the messages of which are then processed to establish the measurement biases, allows the reliability and precision of this selection to be improved because the external position is more precise than the internal position. This therefore allows the measurement biases to be established more precisely and therefore a more precise external position to be obtained at time tₖ. In addition, this does not compromise the robustness of the locating method because the external position only influences selection of the processed messages. In particular, the external position does not influence the content of these messages, their times of receipt and does not influence the processing operations executed to establish the measurement biases.

Minimizing the difference between the measurement biases for times tₖ and tₖ₋₁ increases the precision of the location.

Use of the parametrized model to estimate the error caused by propagation of the messages of the beacons through the ionosphere or troposphere allows the precision of the location to be enhanced.

1. A method for locating a navigation unit in an environment containing beacons transmitting messages, the method comprising execution of the following steps for each time tₖ of a temporal sequence of times {t₀; . . . , t₋₁; tₖ; . . . };
(a) receiving messages transmitted by at least three beacons,
(b) extracting raw measurements of pseudoranges separating the navigation unit from each of the at least three beacons based on times of receipt of the messages as measured by the navigation unit and on a speed of propagation of the messages through space,
(c) estimating an internal position of the navigation unit at the time tₖ based on the raw measurements extracted for the time t_{k,i} on a preceding internal position of the navigation unit estimated at the time tₖ₋₁ and on positions of the beacons,
(d) for a plurality of beacons, establishing a measurement bias for the time tₖ that, when subtracted from the raw measurement extracted based on the time of receipt of the message transmitted by th beacon, allows an error affecting i the raw measurement to be decreased, the measurement bias being established based on a difference between:
(1) computed pseudorange separating the beacon from the navigation unit, the computed pseudorange being computed based on a position of the beacon and on an internal position of the navigation unit estimated for the time tₖ, and
(2) a measured pseudorange separating the beacon from the navigation unit, the measured pseudorange being computed based on the raw pseudorange measurement extracted for the beacon for the time tₖ and without taking into account the internal position of the navigation unit,
(e) for each beacon for which a measurement bias was established for the time tₖ, computing a corrected measurement of the pseudorange at the time tₖ by adding the measurement bias established for the beacon to a raw measurement of the pseudorange for the beacon extracted at the time tₖ, and
(f) estimating an external position of the navigation unit at the time tₖ based on:
(i) positions of the beacons for which a corrected measurement of the pseudorange at the time tₖ was computed,
(ii) corrected pseudorange measurements computed for the time tₖ, and
(iii) the preceding external position of the navigation unit estimated for the preceding time tₖ₋₁,
wherein steps (b), (c) and (d) are performed without taking into account the external position of the navigation unit.

2. The method according to claim 1, wherein:
the method comprises, after step (b) and before step (c), selecting, depending on the external position of the navigation unit at the preceding time tₖ₋₁ a limited number of raw measurements extracted from all the raw measurements extracted in step (b) for the time tₖ, and
in steps (c) and (d), only the raw measurements thus selected are used, and the raw measurements not selected are ignored.

3. The method according to claim 1, wherein each measurement bias for the time tₖ is also established by minimizing a difference between the measurement bias for the time tₖ and the measurement bias established for the preceding time tₖ.

4. The method according to claim 1, wherein each beacon is a satellite in orbit around the Earth.

5. The method according to claim 4, wherein after step (b) and before step (c), the method comprises a step of pre-correcting the extracted raw measurements, the pre-correcting step comprising, for each beacon having transmitted a message based on which a pseudorange is extracted:
establishing an error caused by propagation of the message of the beacon through the ionosphere or the troposphere, a predetermined model parametrized by the internal position of the navigation unit estimated for the preceding time tₖ₋₁ being used, and
subtracting the established error from the extracted raw measurement to obtain a pre-corrected raw measurement, and
in steps (c) and (d), using the pre-corrected raw measurements.

6. A non-transitory data storage medium that is readable by a microprocessor, comprising instructions that are executable by the microprocessor, wherein the medium comprises non-transitory instructions for executing a locating method according to claim 1, when the instructions are executed by the microprocessor.

7. A navigation unit configured to move through an environment containing beacons transmitting messages, the navigation unit comprising:
a microprocessor configured to execute the following steps for each time tₖ of a temporal sequence of times {t₀; . . . ; tₖ₋₁; tₖ; . . . };
(a) receiving messages transmitted by at least three beacons,
(b) extracting raw measurements of pseudoranges separating the navigation unit from each of the at least three beacons based on times of receipt of the messages as measured by the navigation unit and on a speed of propagation of the messages through space,
(c) estimating an internal position of the navigation unit at the time tₖ based on the raw measurements extracted for the time tₖ, on a preceding internal position of the navigation unit estimated at the time tₖ₋₁ and on positions of the beacons,
(d) for a plurality of beacons, establishing a measurement bias for the time tₖ that, when subtracted from the raw measurement extracted based on the time of receipt of the message transmitted by the beacon, allows an error affecting the raw measurement to be decreased, the measurement bias being established based on a difference between:
(1) a computed pseudorange separating the beacon from the navigation unit, the computed pseudorange being computed based on a position of the beacon and on an internal position of the navigation unit estimated for the time tₖ, and
(2) a measured pseudorange separating the beacon from the navigation unit, the measured pseudorange being computed based on the raw pseudorange measurement extracted for the beacon for the time tₖ and without taking into account the internal position of the navigation unit,
(e) for each beacon for which a measurement bias was established for the time tₖ, computing a corrected measurement of the pseudorange at the time tₖ by adding the measurement bias established for the beacon to a raw measurement of the pseudorange for t beacon extracted at the time tₖ,
(f) estimating an external position of the navigation unit at the time tₖ based on:
(i) positions of the beacons for which a corrected measurement of the pseudorange at the time tₖ was computed,
(ii) corrected pseudorange measurements computed for the time tₖ,
(iii) the preceding external position of the navigation unit estimated for the preceding time tₖ₋₁;
wherein steps (b), (c), and (d) are performed without taking into account the external position of the navigation unit.
